(19) United States
(12) Patent Application Publication
(10) Pub. No.: US 2013/0245930 A1
(43) Pub. Date: Sep. 19, 2013

(54) NAVIGATION SYSTEM WITH POINT OF INTEREST RELATIONSHIP MECHANISM AND METHOD OF OPERATION THEREOF

(71) Applicants: Aliasgar Mumtaz Husain, Milpitas, CA (US); Shirish Kumar, Cupertino, CA (US)

(72) Inventors: Aliasgar Mumtaz Husain, Milpitas, CA (US); Shirish Kumar, Cupertino, CA (US)

(73) Assignee: TELENAV, INC., Sunnyvale, CA (US)

(21) Appl. No.: 13/419,346

(22) Filed: Mar. 13, 2012

(51) Int. Cl. G01C 21/00

(52) U.S. Cl. 701/400

(57) ABSTRACT

A method of operation of a navigation system includes: locating a target POI; generating a relationship for the target POI and a related POI; and generating a travel route based on the relationship to the target POI for displaying on a device.

### TECHNICAL FIELD

The present invention relates generally to a navigation system, and more particularly to a system for point of interest relationship mechanism.

### BACKGROUND ART

Modern portable consumer and industrial electronics, especially client devices such as navigation systems, cellular phones, portable digital assistants, and combination devices, are providing increasing levels of functionality to support modern life including location-based information services. Research and development in the existing technologies can take myriad directions.

As users become more empowered with the growth of mobile location based service devices, new and old paradigms begin to take advantage of this new device space. There are many technological solutions to take advantage of this new device location opportunity. One existing approach is to use location information to provide navigation services such as a global positioning system (GPS) for a car or on a mobile device such as a cell phone, portable navigation device (PND) or a personal digital assistant (PDA).

Location based services allow users to create, transfer, store, and/or consume information in order for users to create, transfer, store, and consume in the “real world”. One such use of location based services is to efficiently transfer or route users to the desired destination or service.

Navigation systems and location based services enabled systems have been incorporated in automobiles, notebooks, handheld devices, and other portable products. Today, these systems aid users by incorporating available, real-time relevant information, such as maps, directions, local businesses, or other point of interest (POI). The real-time information provides invaluable relevant information. However, points of interest (POIs) not easily searchable are of paramount concern to the consumer.

Thus, a need still remains for a navigation system with point of interest relationship mechanism to support accurate searching points of interest by relationship. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: locating a target POI; generating a relationship for the target POI and a related POI; and generating a travel route based on the relationship to the target POI for displaying on a device.

The present invention provides a navigation system, including: a POI locator module for locating a target POI; a relationship module, coupled to the POI locator module, for generating a relationship for the target POI and a related POI; and a route generator module, coupled to the relationship module, for generating a travel route based on the relationship to the target POI for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with point of interest relationship mechanism in an embodiment of the present invention.

FIG. 2 is an example of a display on a display interface of the first device.

FIG. 3 is an exemplary block diagram of the navigation system.

FIG. 4 is a control flow of the navigation system.

FIG. 5 is a control flow of the containment relationship module.

FIG. 6 is a control flow of the adjacency relationship module.

FIG. 7 is a control flow of the across relationship module.

FIG. 8 is a flow chart of a method of operation of the navigation system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

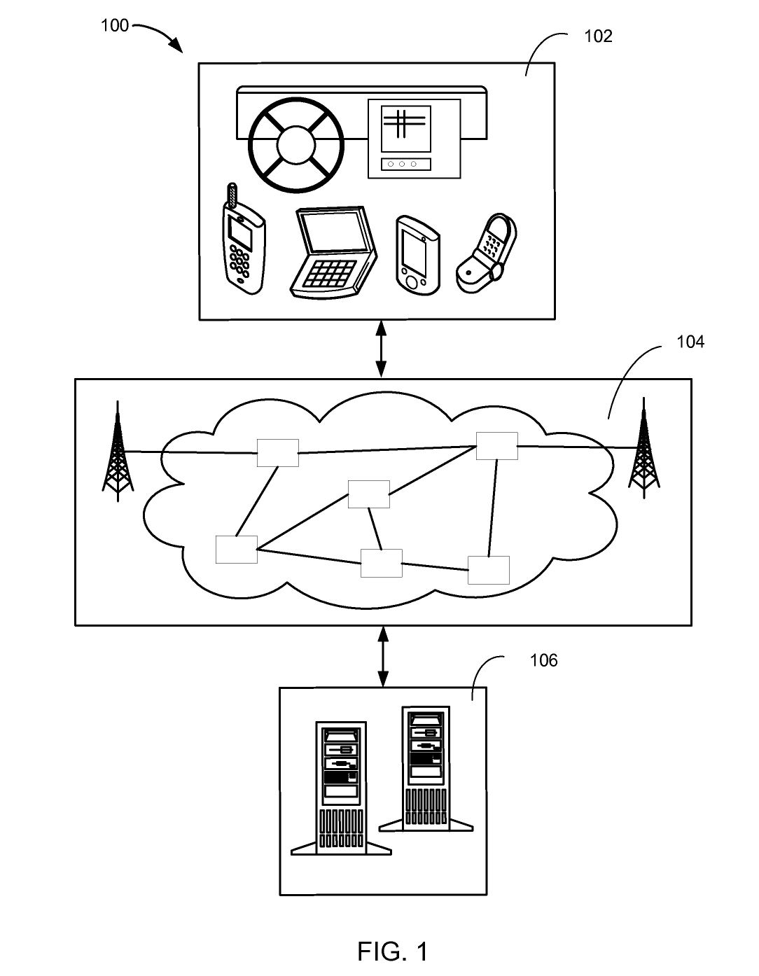

Referring now to FIG. 1, therein is shown is a navigation system 100 with point of interest relationship mechanism in an embodiment of the present invention. The navigation system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the navigation system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10 ™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Palm Centro™, or Moto Q Global™.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

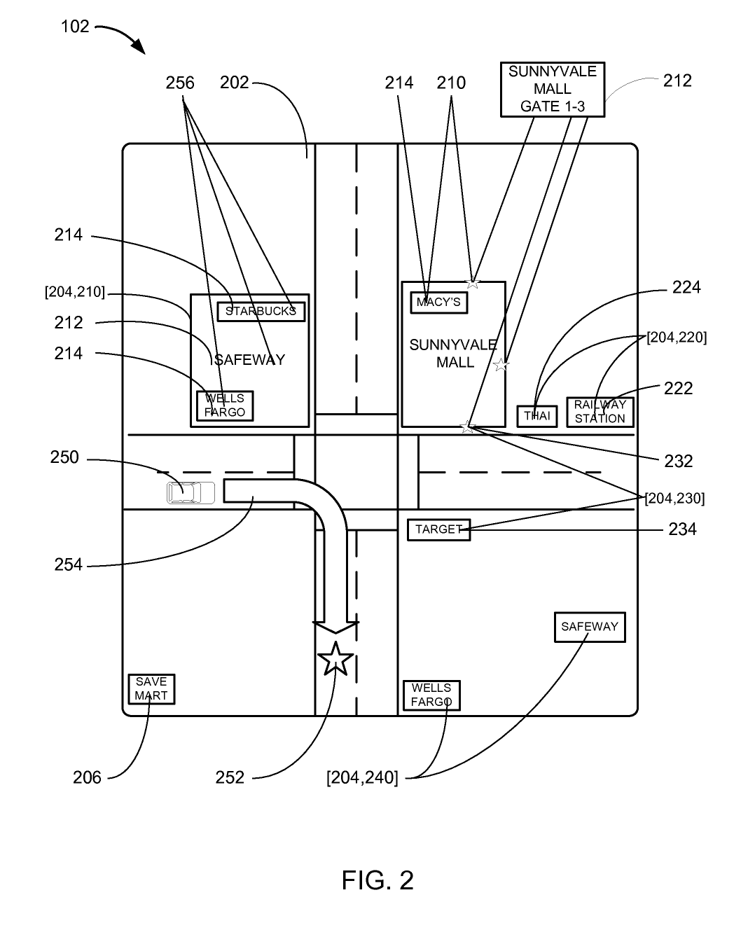

Referring now to FIG. 2, therein is shown an example of a display on a display interface 202 of the first device 102. The display interface 202 can depict a relationship 204, including a validated containment relationship 210, a validated adjacency relationship 220, a validated across relationship 230, and a commonality relationship 240 for a target POI 252 and a related POI 256. The display interface 202 can also depict a travel route 254 from a current location 250 of the navigation system 100 of FIG. 1 to the target POI 252.

The relationship 204 is defined as some interconnections between multiple items. The relationship 204 includes the validated containment relationship 210, the validated adjacency relationship 220, the validated across relationship 230, and the commonality relationship 240 between multiple points of interest. The relationship 204 with the related POI 256 provides richness in describing location of the target POI 252 and helps user navigate to the target POI 252.

The validated containment relationship 210 is defined as interconnections between a validated container POI 212 and a validated contained POI 214. The validated contained POI 214 is a point of interest 206 located in an infrastructure or a building of the validated container POI 212. For example, the validated contained POI 214 can be a Starbucks™ in a Safeway™. In this case, Starbucks™ and Safeway™ have the validated containment relationship 210, Starbucks™ is the validated contained POI 214 in Safeway™, and Safeway™ is the validated container POI 212 that includes Starbucks™. Also for example, Sunnyvale Mall south entrance, the validated container POI 212, has the validated containment relationship 210 with Macy's™, Old Navy™, Gymboree™ and so on which is the validated contained POI 214. The validated containment relationship 210 helps identifying the little known point of interest 206, and leading to the point of interest 206 by navigating to the validated container POI 212. The validated container POI 212 can be a landmark for driving with intent to lead to the validated contained POI 214.

The validated adjacency relationship 220 is defined as interconnections between a validated major adjacent POI 222 and a validated minor adjacent POI 224. The validated minor adjacent POI 224 is defined as the point of interest 206 that has the validated adjacency relationship 220 with the validated major adjacent POI 222 when the validated minor adjacent POI 224 is geographically close to the validated major adjacent POI 222. The validated adjacency relationship 220 does not need to be exactly right next to each other or sharing common wall. The validated minor adjacent POI 224 has the validated adjacency relationship 220 with the validated major adjacent POI 222 which is on the same side of a street block or a strip mall.

For example, That restaurant does not have a same address as the Sunnyvale Mall, and That restaurant is a little bit away from Sunnyvale Mall on the same side of the street. In this case, That restaurant has the validated adjacency relationship 220 with Sunnyvale Mall, That restaurant is the validated minor adjacent POI 224, and Sunnyvale Mall is the validated major adjacent POI 222.

The validated across relationship 230 defines the relationship 204 which a validated major across POI 232 is located across the street to a validated minor across POI 234. The validated major across POI 232 and the validated minor across POI 234 do not have to be exactly opposite to each other. For example, Target™ does not have same address as Sunnyvale Mall, and Target™ is on the other side of the street from Sunnyvale Mall. In this case, Target™ has the validated across relationship 230 with Sunnyvale Mall, Target™ is the validated minor across POI 234, and Sunnyvale Mall is the validated major across POI 232.

The commonality relationship 240 defines the secondary relationship based on the validated containment relationship 210 which the validated contained POI 214 is not located in the validated container POI 212 in some areas. For example, Starbucks™ and Wells Fargo™ can be typically found in Safeway™. The commonality relationship 240 helps navigating to Safeway™ first, but there is no Wells Fargo™ in the Safeway™ in some areas. The commonality relationship 240 can help to find nearby Wells Fargo™.

The related POI 256 is defined as the point of interest 206 which has the relationship 204 with the target POI 252 being selected or searched. The navigation system 100 can search or calculate the travel route 254 for the target POI 252 based on the relationship 204 with the related POI 256.

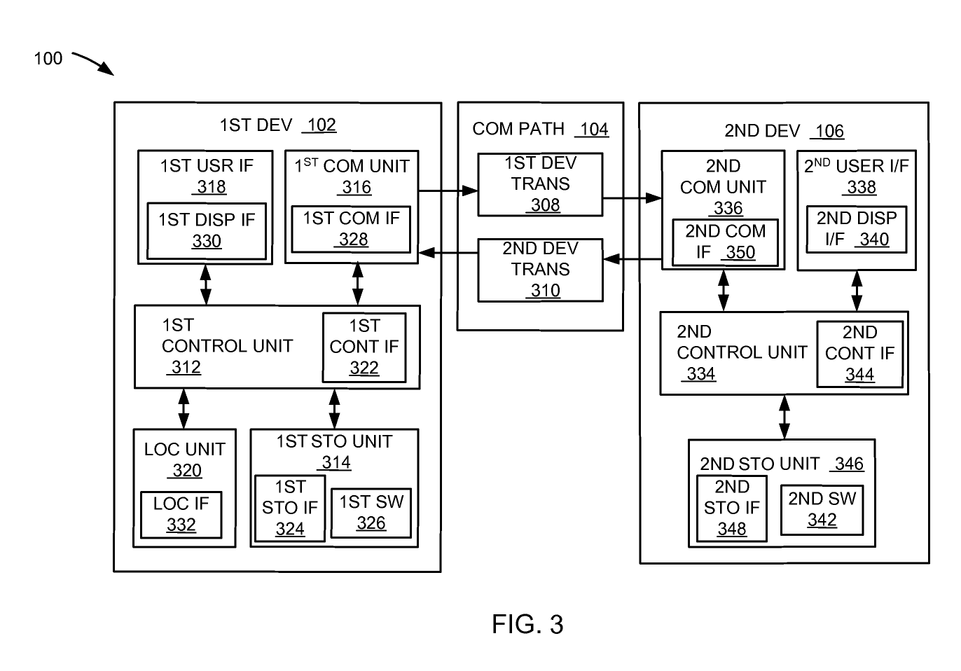

Referring now to FIG. 3, therein is shown an exemplary block diagram of the navigation system 100. The navigation system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the navigation system 100 is shown with the first device 102 as a client device, although it is understood that the navigation system 100 can have the first device 102 as a different type of device. For example, the first device 102 can be a server.

Also for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 312, a first storage unit 314, a first communication unit 316, a first user interface 318, and a location unit 320. The first device 102 can be similarly described by the first device 102.

The first control unit 312 can include a first control interface 322. The first control unit 312 can execute a first software 326 to provide the intelligence of the navigation system 100. The first control unit 312 can be implemented in a number of different manners. For example, the first control unit 312 can be a processor, an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The location unit 320 can generate location information, current heading, and current speed of the first device 102, as examples. The location unit 320 can be implemented in many ways. For example, the location unit 320 can function as at least a part of a global positioning system (GPS), an inertial navigation system, a cellular-tower location system, a pressure location system, or any combination thereof.

The location unit 320 can include a location interface 332. The location interface 332 can be used for communication between the location unit 320 and other functional units in the first device 102. The location interface 332 can also be used for communication that is external to the first device 102.

The location interface 332 can receive information from the other functional units or from external sources, or can transmit information to the other functional units or to external destinations. The external sources and the external destinations refer to sources and destinations external to the first device 102.

The location interface 332 can include different implementations depending on which functional units or external units are being interfaced with the location unit 320. The location interface 332 can be implemented with technologies and techniques similar to the implementation of the first control interface 322.

The first storage unit 314 can store the first software 326. The first storage unit 314 can also store the relevant information, such as advertisements, point of interest (POI), navigation routing entries, reviews/ratings, feedback, traffic patterns, or any combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between the location unit 320 and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, or any combination thereof to provide data and communication inputs.

The first user interface 318 can include a first display interface 330. The first display interface 330 can include a display, a projector, a video screen, a speaker, or any combination thereof.

The first control unit 312 can operate the first user interface 318 to display information generated by the navigation system 100. The first control unit 312 can also execute the first software 326 for the other functions of the navigation system 100, including receiving location information from the location unit 320. The first control unit 312 can further execute the first software 326 for interaction with the communication path 104 via the first communication unit 316.

The second device 106 can be optimized for implementing the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the navigation system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the navigation system 100, including operating the second communication unit 336 to communicate with the first device 102 over the communication path 104.

The second control unit 334 can be implemented in a number of different manners. For example, the second control unit 334 can be a processor, an embedded processor, a microprocessor, a hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the relevant information, such as advertisements, points of interest, navigation routing entries, reviews/ratings, feedback, traffic patterns, or any combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the navigation system 100 is shown with the second storage unit 346 as a single hierarchy storage system, although it is understood that the navigation system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between the location unit 320 and other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The navigation system 100 can be executed by the first control unit 312, the second control unit 334, or a combination thereof.

For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules and functions of the navigation system 100. For example, the first device 102 is described to operate the location unit 320, although it is understood that the second device 106 can also operate the location unit 320.

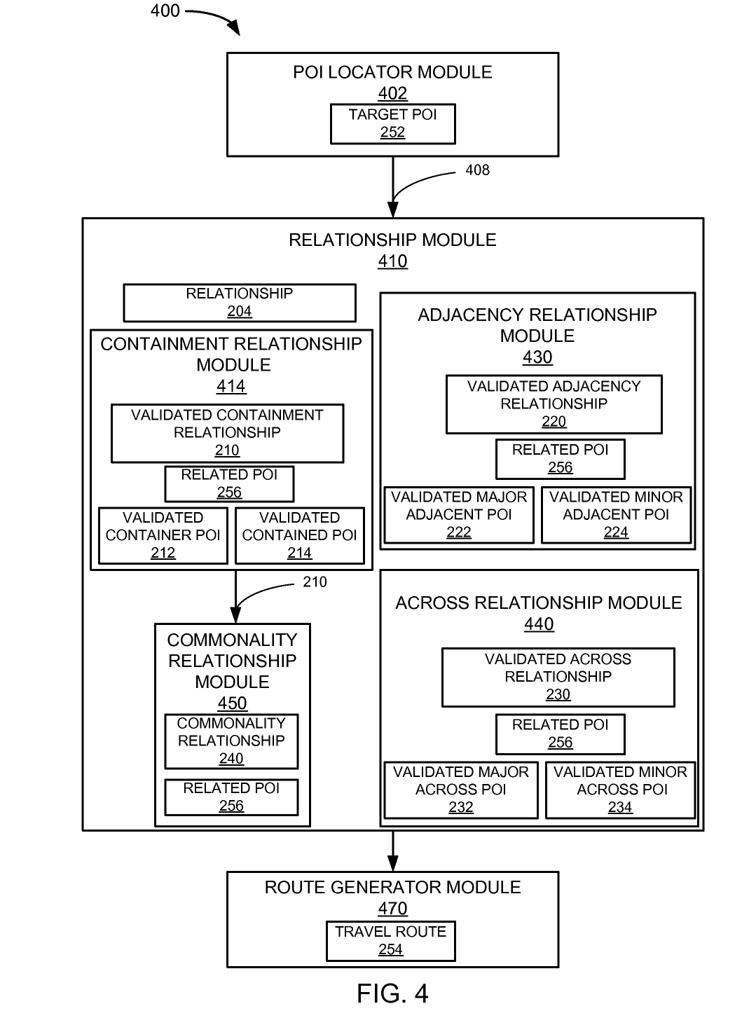

Referring now to FIG. 4, therein is shown a control flow of the navigation system 100. The navigation system 100 can include a POI locator module 402. The POI locator module 402 locates the target POI 252 and outputs a geo-location 408 associated with the target POI 252.

The geo-location 408 is defined as the identification of the real-world geographic location of an object. For example, the global positioning system (GPS) for the car or the mobile device such as the cell phone, portable navigation device (PND), the personal digital assistant (PDA), or an internet-connected computer terminal. The geo-location 408 can refer to the practice of assessing the location, or to the actual assessed location.

The navigation system 100 can also include a relationship module 410, coupled to the POI locator module 402. The relationship module 410 generates the relationship 204 for the target POI 252 and the related POI 256 using the geo-location 408 of the points of interest 206 of FIG. 2.

The relationship module 410 can include a containment relationship module 414. The containment relationship module 414 generates the validated containment relationship 210 for the target POI 252 and the related POI 256 based on the geo-location 408 of the points of interest 206. The process of the containment relationship module 414 will be detailed later in the specification.

The relationship module 410 can also include an adjacency relationship module 430, coupled to the POI locator module 402. The adjacency relationship module 430 generates the validated adjacency relationship 220 for the target POI 252 and the related POI 256 using the geo-location 408 of the points of interest 206. The process of the adjacency relationship module 430 will be detailed later in the specification.

The relationship module 410 can also include an across relationship module 440, coupled to the POI locator module 402. The across relationship module 440 generates the validated across relationship 230 for the target POI 252 and the related POI 256 using the geo-location 408 of the points of interest 206. The process of the across relationship module 440 will be detailed later in the specification.

The relationship module 410 can also include a commonality relationship module 450, coupled to the containment relationship module 414. The commonality relationship module 450 generates the commonality relationship 240 for the target POI 252 and the related POI 256 based on the validated container POI 212 and the validated contained POI 214 from the containment relationship module 414.

The navigation system 100 can also include a route generator module 470, coupled to the relationship module 410. The route generator module 470 generates the travel route 254 for the user to navigate to the target POI 252. For example, the route generator module 470 can generate the travel route 254 based on the target POI 252 for displaying on the first device 102 of FIG. 1. The route generator module 470 can generate the travel route 254 from the current location 250 of FIG. 2 of the navigation system 100 to the target POI 252.

The POI locator module 402 can be implemented by the navigation system 100. The POI locator module 402 can be implemented by the second control unit 334 of FIG. 3, and can make use of the second storage unit 346 of FIG. 3, the second software 342 of FIG. 3, the second communication unit 336 of FIG. 3, or some combination thereof.

For example, the POI locator module 402 can receive the target POI 252 from the second communication unit 336 and store the target POI 252 in the second storage unit 346 by utilizing the second control unit 334. The POI locator module 402 can also utilize the second control unit 334 to operate the second software 342 to generate the geo-location 408 and store the geo-location 408 in the second storage unit 346.

For illustrative purposes, the POI locator module 402 is described as being implemented by the second control unit 334, although it is understood that the POI locator module 402 can be implemented differently. For example, the POI locator module 402 can utilize the first control unit 312 of FIG. 3 retrieve the geo-location 408 from the first storage unit 314 of FIG. 3. The POI locator module 402 can utilize the first control unit 312 to control the first software 326 of FIG. 3 to operate the first communication unit 316 of FIG. 3 and transit the geo-location 408 to the second storage unit 346.

The relationship module 410 can be implemented by the navigation system 100. The relationship module 410 can be implemented with the first control unit 312 of FIG. 3 and can make use of the first software 326 of FIG. 3, the first storage unit 314 of FIG. 3, the first communication unit 316 of FIG. 3, or some combination thereof. For example, the relationship module 410 can receive the geo-location 408 and store the geo-location 408 in the first storage unit 314 by utilizing the first control unit 312.

The relationship module 410 can use the first communication unit 316 to receive the geo-location 408 from the second software 342 which can be implemented by the second control unit 334 and then store the geo-location 408 in the first storage unit 314. The relationship module 410 can utilize the first control unit 312 to operate the first software 326 to generate the validated containment relationship 210, the validated adjacency relationship 220, the validated across relationship 230, the commonality relationship 240, or a combination thereof for the target POI 252 and the related POI 256.

For illustrative purposes, the relationship module 410 is described as being implemented by the first control unit 312, with values being stored in the first storage unit 314, although it is understood that the relationship module 410 can be implemented differently. For example, the relationship module 410 can be implemented by the second control unit 334, with the geo-location 408 being stored in the second storage unit 346 of FIG. 3. Also for example, the second control unit 334 can generate the relationship 204 and use the second communication unit 336 of FIG. 3 to send the relationship 204 to the first storage unit 314.

The route generator module 470 can be implemented by the navigation system 100. The route generator module 470 can be implemented with the first control unit 312 of FIG. 3 and can make use of the first software 326 of FIG. 3, the first storage unit 314 of FIG. 3, the first communication unit 316 of FIG. 3, or some combination thereof.

For example, the route generator module 470 can receive the relationship 204 from the relationship module 410 and store the relationship 204 in the first storage unit 314 by utilizing the first control unit 312. Also for example, the route generator module 470 can receive the target POI 252 from the first communication unit 316 and store the target POI 252 in the first storage unit 314 by utilizing the first control unit 312. The route generator module 470 can also utilize the first control unit 312 to operate the first software 326 to generate the travel route 254 based on the relationship 204 to the target POI 252 for displaying on the first device 102.

For illustrative purposes, the route generator module 470 is described as being implemented by the first control unit 312, although it is understood that the route generator module 470 can be implemented differently. For example, the route generator module 470 can utilize the second control unit 334 to retrieve the relationship 204 from the second storage unit 346. The route generator module 470 can utilize the second control unit 334 to control the second software 342 to operate the second display interface 340 of FIG. 3 to display the travel route 254.

The modules can be implemented with hardware implementations, including hardware acceleration units (not shown) in the first control unit 312 or the second control unit 334, or separate hardware blocks (not shown)/functional units (not shown) in the first device 102 or the second device 106 of FIG. 1 outside the first control unit 312 and the second control unit 334.

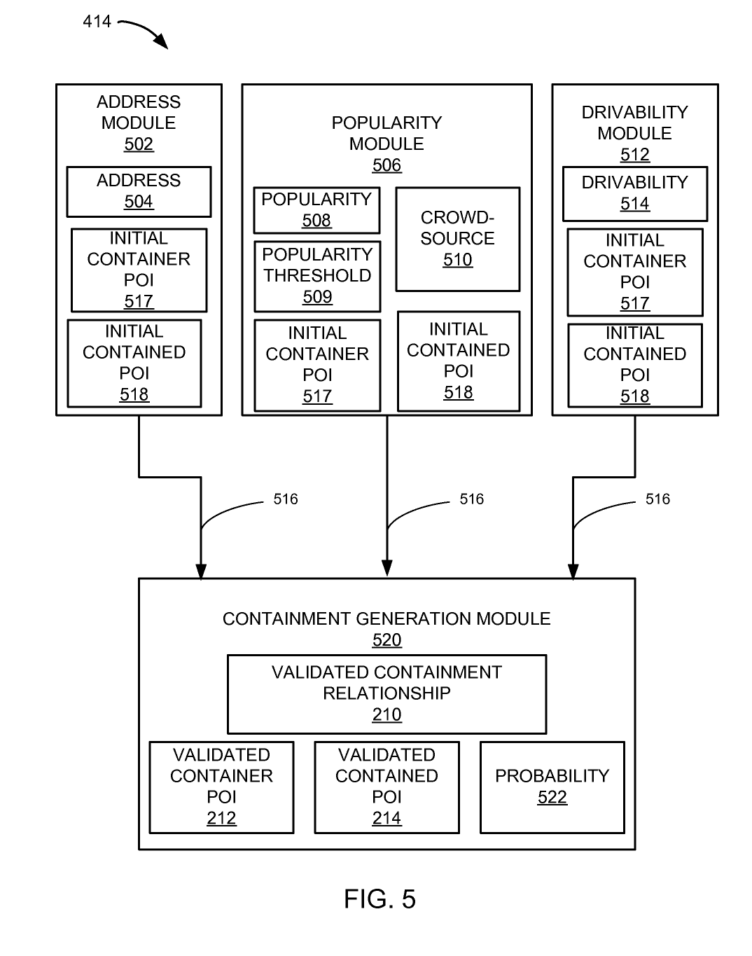

Referring now to FIG. 5, therein is shown a control flow of the containment relationship module 414. The containment relationship module 414 generates the validated containment relationship 210, including the validated container POI 212 and the validated contained POI 214, for the target POI 252 of FIG. 4 and the related POI 256 of FIG. 4.

The containment relationship module 414 can include an address module 502. The address module 502 generates an initial containment relationship 516, including an initial container POI 517 and an initial contained POI 518, and a probability 522 from an address 504 for the target POI 252 and the related POI 256. The initial containment relationship 516 can be determined based on same address but different suite number, or same address but different brand name. For example, there are many doctors in El Camino Hospital located at 701 El Camino Real, Mountain View, Calif. The initial container POI 517 is El Camino Hospital and the initial contained POI 518 is the doctor. Also for example, CPAs are contained in CPA firm, lawyers are contained in law firm, and dentists are contained in dental poly clinics.

The probability 522 is defined as the degree of certainty which is described in terms of a numerical measure and this number is between 0 and 1. For example, if there are 99 related POIs 256 for the target POI 252, and the relationship module 410 of FIG. 4 generates the same relationship 204 of FIG. 2 among 97 of the points of interest 206 of FIG. 2, then the probability 522 of the relationship 204 for the target POI 252 is 0.97.

The containment relationship module 414 can also include a popularity module 506. The popularity module 506 generates the initial containment relationship 516 and the probability 522 based on a popularity 508 or a crowd-source 510 for the target POI 252 and the related POI 256.

The popularity 508 is defined as more people drive to the initial container POI 517 than the initial contained POI 518. The point of interest 206 is determined to be the initial container POI 212 when the number of trips users drive to the target POI 252 or the related POI 256 is meeting or exceeding a popularity threshold 509. On the other hand, the point of interest 206 is the initial contained POI 214 when the number of trips users drive to the target POI 252 or the related POI 256 is below the popularity threshold 509.

For example, there are 990 people drive to Sunnyvale Mall, but only 10 people drive to Macy's™. The popularity module 506 can determine that Sunnyvale Mall is the initial container POI 517, Macy's™ is the initial contained POI 518.

The popularity module 506 can also generate the initial containment relationship 516 and the probability 522 based on the crowd-source 510 when more users explicitly report driving to the initial container POI 517 than driving to the initial contained POI 518. For example, there are 500 users report driving to Stanford Mall, but only 5 people report driving to Banana Republic™ through a survey. The popularity module 506 can determine that Stanford Mall is the initial container POI 517, Banana Republic™ is the initial contained POI 518.

The containment relationship module 414 can also include a drivability module 512. The drivability module 512 generates the initial containment relationship 516, including the initial container POI 517 and the initial contained POI 518, and the probability 522 based on a drivability 514 of the target POI 252 and the related POI 256.

The drivability 514 can be determined based on how many users search for the initial contained POI 518 but end up driving to the initial container POI 517. For example, the drivability 514 to a doctor in Kaiser Permanente is 0, but the drivability 514 to Kaiser Permanente is 1. Kaiser Permanente is a single geocodable address that can be driven to.

Also for example, there are a lot of users search for California Pizza Kitchen and end up driving to Valley Fair South Entrance. The drivability module 512 can determine that Valley Fair South Entrance is the initial container POI 517 and California Pizza Kitchen is the initial contained POI 518.

The containment relationship module 414 can also include a containment generation module 520. The containment generation module 520 determines the validated containment relationship 210, including the validated container POI 212 and the validated contained POI 214, based on the initial containment relationship 516 and the probability 522 from the address module 502, the popularity module 506, and the drivability module 516. The containment generation module 520 determines the initial containment relationship 210 with the highest value of the probability 522 to be the validated containment relationship 210.

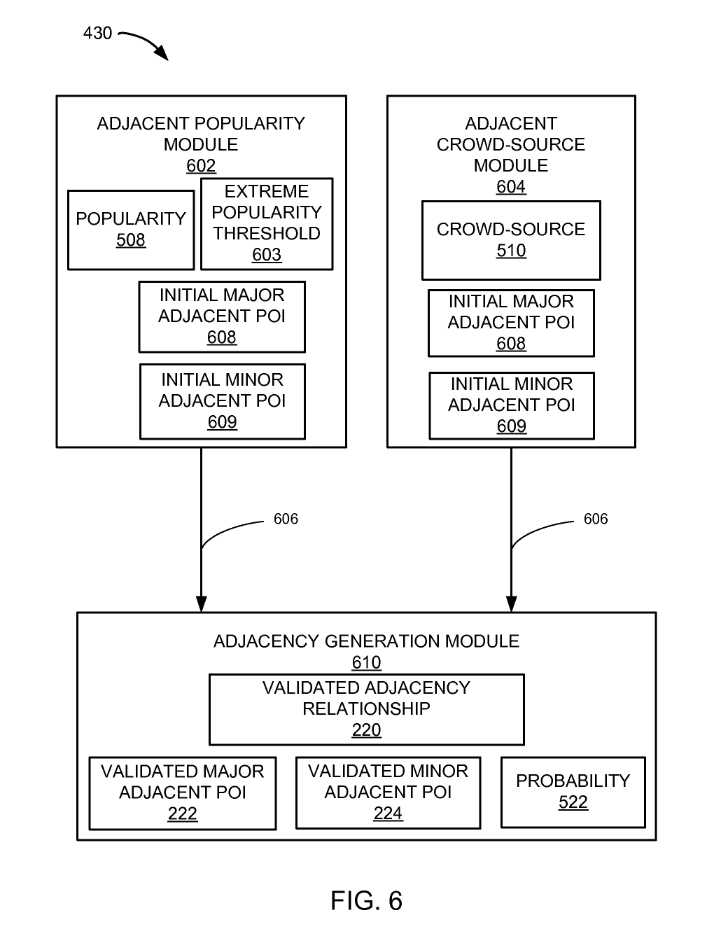

Referring now to FIG. 6, therein is shown a control flow of the adjacency relationship module 430. The adjacency relationship module 430 generates the validated adjacency relationship 220, including the validated major adjacent POI 222 and the validated minor adjacent POI 224, for the target POI 252 of FIG. 4 and the related POI 256 of FIG. 4.

The adjacency relationship module 430 can include an adjacent popularity module 602. The adjacent popularity module 602 generates an initial adjacency relationship 606, including an initial major adjacent POI 608, an initial minor adjacent POI 609, and the probability 522 based on the popularity 508 being meeting or exceeding the popularity threshold 509 of FIG. 5 for the target POI 252 and the related POI 256.

For example, Sunnyvale mall is on the same side of the road as That restaurant which is less than 0.1 mile or a block or two away from Sunnyvale Mall. There is more users drive to Sunnyvale Mall than to That Restaurant. The adjacent popularity module 602 determines that Sunnyvale Mall is the initial major adjacent POI 608 and That Restaurant is the initial minor adjacent POI 609.

If the popularity 508 for the target POI 252 is very high, being meeting or exceeding an extreme popularity threshold 603, and the distance between the initial major adjacent POI 222 and the initial minor adjacent POI 224 is more than 0.1 mile, the distance window for the initial major adjacent POI 222 that is extremely popular could be expanded up to 0.2 mile. For example, there are more people driving to Sunnyvale Railway Station which is 0.2 miles away from That restaurant than to Sunnyvale Mall which is 0.1 mile away from That restaurant. Sunnyvale Railway Station is the initial major adjacent POI 222 and That restaurant is the initial minor adjacent POI 224 since Sunnyvale Railway Station is an extremely popular POI even though it is 0.2 miles away from That Restaurant. That Restaurant has the initial adjacency relationship 220 with Sunnyvale Railway Station instead of Sunnyvale Mall.

The adjacency relationship module 430 can also include an adjacent crowd-source module 604. The adjacent crowd-source module 604 generates the initial adjacency relationship 606, including the initial major adjacent POI 608 and the initial minor adjacent POI 609, and the probability 522 based on the crowd-source 510 for the target POI 252 and the related POI 256. The crowd-source 510 is explicitly reported from users about trips to the target POI 252 through internet survey, user feedback, or a combination thereof.

The adjacency relationship module 430 can also include an adjacency generation module 610. The adjacency generation module 610 generates the validated adjacency relationship 220, including the validated major adjacent POI 222 and the validated minor adjacent POI 224, based on the initial adjacency relationship 606 and the probability 522 from the adjacent popularity module 602 and the adjacent crowd-source module 604. The adjacency generation module 610 determines the initial adjacency relationship 606 with the higher value of the probability 522 to be the validated adjacency relationship 220.

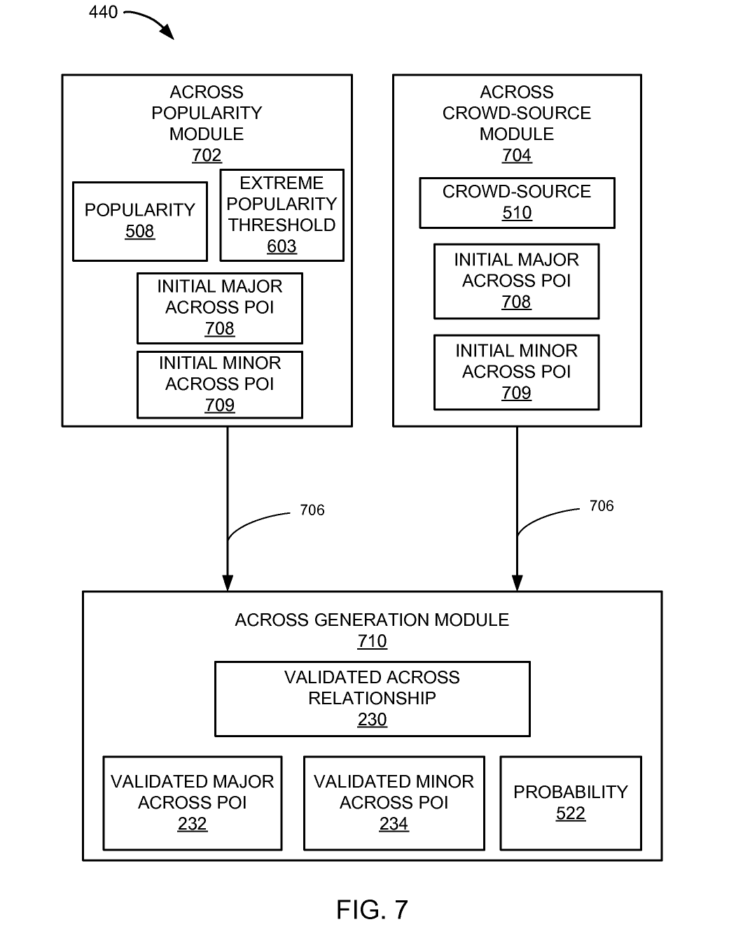

Referring now to FIG. 7, therein is shown a control flow of the across relationship module 440. The across relationship module 440 generates the validated across relationship 230, including the validated major across POI 232 and the validated minor across POI 234, for the target POI 252 of FIG. 4 and the related POI 256 of FIG. 4. The validated across relationship 230 is similar to the validated adjacency relationship 220 of FIG. 2, but the validated minor across POI 234 is located across the street to the validated major across POI 232. The validated minor across POI 234 is on the other side of the street to the validated major across POI 232.

The across relationship module 440 can include an across popularity module 702. The across popularity module 702 generates an initial across relationship 706, including an initial major across POI 708, an initial minor across POI 709, and the probability 522 based on the popularity 508 being meeting or exceeding the popularity threshold 509 of FIG. 5 for the target POI 252 and the related POI 256.

For example, Sunnyvale mall is on the other side of the road as Target™ which is less than 0.1 mile or a block or two away from Sunnyvale Mall. There is more users drive to Sunnyvale Mall than to Target™. The across popularity module 702 determines that Sunnyvale Mall is the initial major across POI 708 and Target™ is the initial minor across POI 709.

If the popularity 508 for the point of interest 206 of FIG. 2 is very high, being meeting or exceeding the extreme popularity threshold 603, and the distance between the initial major across POI 232 and the initial minor across POI 234 is more than 0.1 mile, the distance window for the initial major across POI 232 that is extremely popular can be expanded up to 0.2 mile. For example, there are more people driving to Sunnyvale Railway Station which is 0.2 miles away from Target™ than to Sunnyvale Mall which is 0.1 mile away from Target™. In this case, Sunnyvale Railway Station is the initial major across POI 232 and Target™ is the initial minor across POI 234 since Sunnyvale Railway Station is an extremely popular POI even though it is 0.2 miles away from Target™. Target™ has the initial across relationship 230 with Sunnyvale Railway Station instead of Sunnyvale Mall.

The across relationship module 440 can also include an across crowd-source module 704. The across crowd-source module 704 generates the initial across relationship 706, including the initial major across POI 708 and the initial minor across POI 709, and the probability 522 for the target POI 252 and the related POI 256. The crowd-source 510 is generated base on internet surveys, user feedback, or a combination thereof, that users explicitly report trips to the point of interest 206.

The across relationship module 440 can also include an across generation module 710. The across generation module 710 generates the validated across relationship 230, including the validated major across POI 232 and the validated minor across POI 234, based on the initial across relationship 706 and the probability 522 from the across popularity module 702 and the across crowd-source module 704. The across generation module 710 determines the initial across relationship 706 with the higher value of the probability 522 to be the validated across relationship 230.

Thus, it has been discovered that the navigation system 100 of FIG. 1 of the present invention furnishes important and heretofore unknown and unavailable solutions, capabilities, and functional aspects for generating the relationship 204 of FIG. 2 using the geo-location 408 of FIG. 4 for the target POI 252 and the related POI 256. The present invention generates the relationship 204, including the validated containment relationship 210 of FIG. 2, the validated adjacency relationship 220, the validated across relationship 230, and the commonality relationship 240 of FIG. 2 for the target POI 252 and the related POI 256. As a result, the user can use the navigation system 100 with more accurate information about the target POI 252 and the related POI 256. The navigation result is improved by calculating the travel route 254 of FIG. 2 base on the relationship 204 for the target POI 252 and the related POI 256.

The physical transformation from displaying the travel route 254 calculated based on the relationship 204 to the target POI 252 and the related POI 256 results in movement in the physical world, such as people using the first device 102 of FIG. 1, the vehicle, or a combination thereof, based on the operation of the navigation system 100. As the movement in the physical world occurs, the movement itself creates additional information that is converted back to the relationship 204 for the target POI 252 and the related POI 256 for the continued operation of the navigation system 100 and to continue the movement in the physical world.

The navigation system 100 describes the module functions or order as an example. The modules can be partitioned differently. For example, the POI locator module 402 of FIG. 4 and the relationship module 410 of FIG. 4 can be combined. Each of the modules can operate individually and independently of the other modules.

Furthermore, data generated in one module can be used by another module without being directly coupled to each other. For example, the route generator module 470 of FIG. 4 can receive the geo-location 408 from the POI locator module 402.

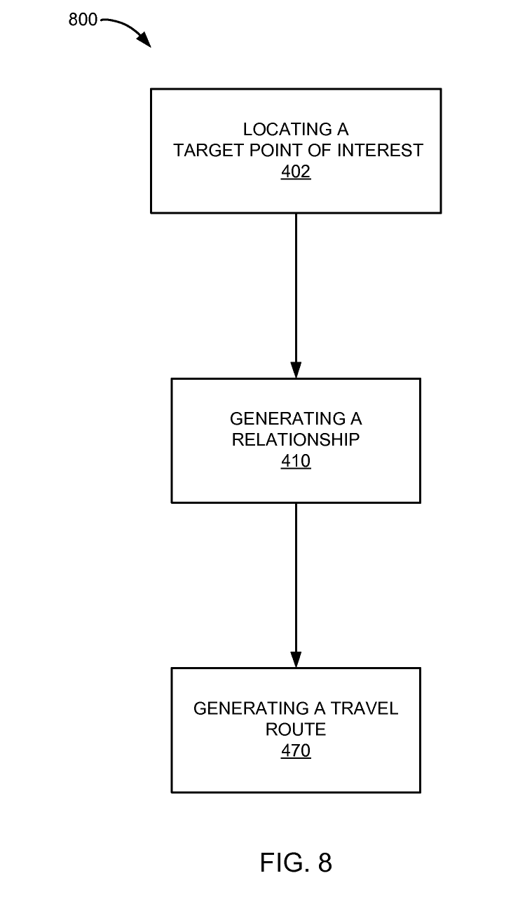

Referring now to FIG. 8, therein is shown a flow chart of a method 800 of operation of the navigation system 100 of FIG. 1 in a further embodiment of the present invention. The method 800 includes: locating a target POI in a block 402; generating a relationship for the target POI and a related POI in a block 410; and generating a travel route based on the relationship to the target POI for displaying on a device in a block 470.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
locating a target POI;
generating a relationship for the target POI and a related POI; and
generating a travel route based on the relationship to the target POI for displaying on a device.

2. The method as claimed in claim 1 wherein generating the relationship includes:
generating a validated containment relationship, including a validated container POI and a validated contained POI, for the target POI and the related POI.

3. The method as claimed in claim 1 wherein generating the relationship includes:
generating a validated adjacency relationship, including a validated major adjacent POI and a validated minor adjacent POI, for the target POI and the related POI.

4. The method as claimed in claim 1 wherein generating the relationship includes:
generating a validated across relationship, including a validated major across POI and a validated minor across POI, for the target POI and the related POI.

5. The method as claimed in claim 1 wherein generating the relationship includes:
generating a commonality relationship based on a validated containment relationship for the target POI and the related POI.

6. A method of operation of a navigation system comprising:
locating a target POI;
generating a relationship for the target POI and a related POI; and
generating a travel route to the target POI or the related POI based on the relationship for displaying on a device.

7. The method as claimed in claim 6 wherein generating the relationship includes:
generating an initial containment relationship and a probability based on an address for the target POI and the related POI;
generating the initial containment relationship and the probability based on a popularity for the target POI and the related POI;
generating the initial containment relationship and the probability based on a drivability for the target POI and the related POI; and
determining a validated containment relationship based on the initial containment relationship with the highest value of the probability.

8. The method as claimed in claim 6 wherein generating the relationship includes:
generating an initial containment relationship and a probability based on an address for the target POI and the related POI;
generating the initial containment relationship and the probability based on a crowd-source for the target POI and the related POI;
generating the initial containment relationship and the probability based on a drivability for the target POI and the related POI; and
determining a validated containment relationship based on the initial containment relationship with the highest value of the probability.

9. The method as claimed in claim 6 wherein generating the relationship includes:
generating an initial adjacency relationship and a probability based on a popularity for the target POI and the related POI;
generating the initial adjacency relationship and the probability based on a crowd-source for the target POI and the related POI; and
determining a validated adjacency relationship based on the initial adjacency relationship with the higher value of the probability.

10. The method as claimed in claim 6 wherein generating the relationship includes:
generating an initial across relationship and a probability based on a popularity for the target POI and the related POI;
generating the initial across relationship and the probability based on a crowd-source for the target POI and the related POI; and
determining a validated across relationship based on the initial across relationship with the higher value of the probability.

11. A navigation system comprising:
a POI locator module for locating a target POI;
a relationship module, coupled to the POI locator module, for generating a relationship for the target POI and a related POI; and
a route generator module, coupled to the relationship module, for generating a travel route based on the relationship to the target POI for displaying on a device.

12. The system as claimed in claim 11 wherein the relationship module includes:
a containment relationship module, coupled to the POI locator module, for generating a validated containment relationship, including a validated container POI and a validated contained POI, for the target POI and the related POI.

13. The system as claimed in claim 11 wherein the relationship module includes:
an adjacency relationship module, coupled to the POI locator module, for generating a validated adjacency relationship, including a validated major adjacent POI and a validated minor adjacent POI, for the target POI and the related POI.

14. The system as claimed in claim 11 wherein the relationship module includes:
an across relationship module, coupled to the POI locator module, for generating a validated across relationship, including a validated major across POI and a validated minor across POI, for the target POI and the related POI.

15. The system as claimed in claim 11 wherein the relationship module includes:
a commonality relationship module, coupled to a containment relationship module, for generating a commonality relationship based on a validated containment relationship for the target POI and the related POI.

16. The system as claimed in claim 11 wherein the route generator module is for generating the travel route to the target POI or the related POI based on the relationship for displaying on the device.

17. The system as claimed in claim 16 wherein the relationship module includes:
an address module, coupled to the POI locator module, for generating an initial containment relationship and a probability based on an address for the target POI and the related POI;
a popularity module, coupled to the POI locator module, for generating the initial containment relationship and the probability based on a popularity for the target POI and the related POI;
a drivability module, coupled to the POI locator module, for generating the initial containment relationship and the probability based on a drivability for the target POI and the related POI; and
a containment generation module, coupled to the popularity module, for determining a validated containment relationship based on the initial containment relationship with the highest value of the probability.

18. The system as claimed in claim 16 wherein the relationship module includes:
an address module, coupled to the POI locator module, for generating an initial containment relationship and a probability based on an address for the target POI and the related POI;
a popularity module, coupled to the POI locator module, for generating the initial containment relationship and the probability based on a crowd-source for the target POI and the related POI;
a drivability module, coupled to the POI locator module, for generating the initial containment relationship and the probability based on a drivability for the target POI and the related POI; and
a containment generation module, coupled to the popularity module, for determining a validated containment relationship based on the initial containment relationship with the highest value of the probability.

19. The system as claimed in claim 16 wherein the relationship module includes:
an adjacent popularity module, coupled to the POI locator module, for generating an initial adjacency relationship and a probability based on a popularity for the target POI and the related POI;
an adjacent crowd-sourced module, coupled to the POI locator module, for generating the initial adjacency relationship and the probability based on a crowd-source for the target POI and the related POI; and
an adjacency generation module, coupled to the adjacent popularity module, for determining a validated adjacency relationship based on the initial adjacency relationship with the higher value of the probability.

20. The system as claimed in claim 16 wherein the relationship module includes:
an across popularity module, coupled to the POI locator module, for generating an initial across relationship and a probability based on a popularity for the target POI and the related POI;
an across crowd-source module, coupled to the POI locator module, for generating the initial across relationship and the probability based on a crowd-source for the target POI and the related POI; and
an across generation module, coupled to the across popularity module, for determining a validated across relationship based on the initial across relationship with the higher value of the probability.
